(19) United States
(12) Patent Application Publication
(10) Pub. No.: US 2026/0200181 A1
(43) Pub. Date: Jul. 16, 2026

(54) PRECISE LIQUID PLACEMENT

(71) Applicant: TAMICARE LIMITED, Manchester (GB)

(72) Inventors: Ehud GILOH, Netanya (IL); Tamar GILOH, Netanya (IL)

(21) Appl. No.: 19/123,785

(22) PCT Filed: Oct. 27, 2023
(86) PCT No.: PCT/IL2023/051111

§ 371 Date: Apr. 24, 2025

Related U.S. Application Data
(60) Provisional application No. 63/419,720, filed on Oct. 27, 2022.

(51) Int. Cl. B29C 70/30; B29C 37/00; B29C 70/12; B29C 70/54; B29C 70/88; B29K 105/04; B29K 105/12

(52) U.S. Cl. CPC B29C 70/305; B29C 70/12; B29C 70/546; B29C 70/887; B29C 2037/903; B29K 2105/04; B29K 2105/12

(57) ABSTRACT

There is provided an additive manufacturing system and method for creating a seamless fabric and/or foam product comprising different properties in different designated sections along the fabric and/or foam product. The system and method comprising depositing polymer liquid droplets via a precise liquid placement (PLP) head, depositing polymer liquid droplets via a high-volume-low-resolution head, and controlling operation of the precise liquid placement (PLP) head and of the high-volume-low-resolution head, thereby controlling the different properties of the seamless fabric and/or foam product, via a computerized control system.

### TECHNICAL FIELD

The present disclosure relates to additive manufacturing for the creation of fabrics and foams comprising different properties in designated sections of the fabric.

### BACKGROUND

Typically, fabrics are manufactured to comprise a homogenous structure throughout the entire piece of fabric. In case one would like to have different properties in one piece of fabric, they would in fact be required to cut different types of fabrics and connect them to one another by gluing them or stitching them to one another. Such methods of connecting two types of fabrics to one another are not efficient for mass production nor do they result in a seamless esthetic product.

There is thus a need for a system and method for the production of seamless fabrics that comprise various properties at designated areas, while enabling precise product structuring by precise materials placement, in an effortless manner.

### SUMMARY

An aspect of an embodiment of the disclosure, relates to a method for manufacturing seamless fabric and/or foam products comprising different properties at predetermined sections along each fabric product.

According to the present disclosure, “fabric” refers to textile, as well as to polymeric sheets, e.g., substitute leather.

The method may comprise accurate deposition of accumulated liquid droplets, possibly with deposition of short loose fibres such as textile fibres, and possibly other additives. The product's attributes, such as thicknesses, colors, stretchability, rigidity, texture, hand-feel, drape, smell, tear strength, puncture resistance, breathability, or any other desired attributes, can be achieved at any predetermined designated section of the product.

Another aspect of an embodiment of the disclosure, relates to an additive manufacturing system for manufacturing seamless fabric and/or foam products comprising different properties at predetermined sections along each fabric product. The system may comprise (1) a precise jet spray gun-comprising an array of outlet holes, through which series of liquid droplets can be disposed or pushed out, at a pre-programmed process, (2) a movable and optionally tiltable holding device, configured to hold the spray gun, the holding device may be capable of moving the jet spray gun (in X, Y, and Z axes) and rolling it (in RX, RY, and RZ axes) allowing controlling the position and angle of the spraying direction, (3) a printing bed, optionally moveable and tiltable, onto which printing of the liquid droplets, together with deposition of short fibres such as textile fibres, and possibly other additives, may be performed, and (4) a software driven computerized control system.

According to some embodiments, an additive manufacturing method for creating a seamless fabric and/or foam product comprising different properties in different designated sections along the fabric and/or foam product, may comprise:
depositing polymer liquid droplets via a precise liquid placement (PLP) head;
depositing polymer liquid droplets via a high-volume-low-resolution head; and
controlling operation of the precise liquid placement (PLP) head and of the high-volume-low-resolution head, thereby controlling the different properties of the seamless fabric and/or foam product, via a computerized control system.

According to some embodiments, the polymer liquid droplets are waterborne polymer or waterborne resin.

According to some embodiments, the method further comprises depositing short loose fibres via a flocking system.

According to some embodiments, the short loose fibres are textile fibres.

In some embodiments, the polymer liquid droplets deposited via a precise liquid placement (PLP) head and the polymer liquid droplets deposited via a high-volume-low-resolution head, comprises additives.

In some embodiments, the additives are fire retardants, scents, blowing agents, conductive elements, colour pigments, or any combination thereof.

Optionally, controlling the operation of the precise liquid placement (PLP) head and of the high-volume-low-resolution head comprises controlling continuous or non-continuous liquid droplets depositing, speed at which each liquid droplet leaves a nozzle of each of the precise liquid placement (PLP) head and of the high-volume-low-resolution head, the amount of liquid deposited in every deposition session, or at any given series of spray session, the type of liquid material applied per every session of droplets application, the order and duration of materials applied per each session of droplets deposition, or any combination thereof.

In some embodiments, controlling the operation of the precise liquid placement (PLP) head comprises controlling number of droplets deposited at every predetermined period of time.

In some embodiments, output rate of the depositing of liquid droplets via the high-volume-low-resolution head is at least two times higher compared to output rate of the depositing of liquid droplets via the precise liquid placement (PLP) head.

Optionally, resolution of the precise liquid placement (PLP) head is at least five times higher compared to resolution of the high-volume-low-resolution head, thereby the depositing of liquid droplets via the precise liquid placement (PLP) head is configured for creating a detailed overlay, while the depositing of liquid droplets via the high-volume-low-resolution head is configured for creating a low detail base overlay or filler overlay, which is configured to serve as a plain layer, or as a first layer onto which the detailed overlay is created, or as a filler neighbouring or surrounding the detailed overlay, respectively, further wherein controlling operation of the precise liquid placement (PLP) is performed with respect to controlling operation of the high-volume-low-resolution heads thereby optimizing operation of the heads with respect to manufacturing time and product quality.

In some embodiments, the controlling the different properties of the fabric and/or foam product comprises controlling attributes of the fabric and/or foam product, per any designated section along the fabric and/or foam product, said attributes of the different designated sections comprising thickness, colour pigments, stretchability, rigidity, texture, hand-feel, drape, smell, tear strength, puncture resistance, breathability, or any combination thereof.

In some embodiments, the different designated sections are anywhere along the X, Y, Z dimensions of the fabric and/or foam product.

In some embodiments, precision and resolution of the depositing via the precise liquid placement (PLP) head is of at least ±1 mm, and wherein the precision and resolution of the high-volume-low-resolution head is between 0.5 cm to 80 cm.

Optionally, controlling the different properties of the foam product comprises controlling softness and weight per volume, by controlling the type of material of the polymer liquid droplets and the ratio between the material of the polymer liquid droplets, air concentration mixed within, or amount of blowing agent mixed within the material of the polymer liquid droplets.

In some embodiments, the method further comprises semi-curing between depositing of one layer to another layer to cause seamless fusion between the layers to create a seamless fabric and/or foam product.

In some embodiments, the method further comprises curing performed after depositing of the polymer liquid droplets is complete.

In some embodiments, there is provided an additive manufacturing system for creating a fabric and/or foam product comprising different properties in different designated sections along the fabric and/or foam product. The system comprising:
a precise liquid placement (PLP) head configured for deposition of accumulated liquid droplets;
a high-volume-low-resolution head configured for deposition of accumulated liquid droplets;
wherein resolution of deposition of the precise liquid placement (PLP) head is higher than resolution of deposition of the high-volume-low-resolution head,
a printing surface configured to receive the accumulated liquid droplets thereon; and
a computerized control system configured to control operation of the precise liquid placement (PLP) head and of the high-volume-low-resolution head, thereby to control the different properties of the fabric and/or foam product.

In some embodiments, the system further comprises an imaging system or camera to track and correct deposition of the polymer liquid droplets to trim and adjust forming the shape of the fabric and/or foam product via communication between the imaging system and the computerized control system, in an continuous manner.

In some embodiments, the printing surface is moveable and tiltable to adjust its position and distance from each of the precise liquid placement (PLP) head and the high-volume-low-resolution head, per predesigned fabric and/or foam product.

Optionally, each of the precise liquid placement (PLP) head and the high-volume-low-resolution head is attached to a movable and tiltable holding device, said movable and tiltable holding device configured to move each of the precise liquid placement (PLP) head and the high-volume-low-resolution head along X, Y, and Z axes, to roll in RX, RY, and RZ axes, thereby to control the angle of deposition direction and the distance and angle between each of the precise liquid placement (PLP) and the high-volume-low-resolution heads and the printing surface.

In some embodiments, each of the precise liquid placement (PLP) and the high-volume-low-resolution heads comprises nozzles through which the liquid droplets exit the heads.

In some embodiments, each of the nozzles of the precise liquid placement (PLP) head is operatively connected to a mechanical pump, via a hose, wherein each pump controls each nozzle separately.

Optionally, the pump controlling each nozzle comprises controlling different amounts of liquid disposed from per each nozzle, different materials disposed from per each nozzle, timing of nozzle operation, or any combination thereof.

In some embodiments, the precise liquid placement head is based on ink jet technology.

In some embodiments, the high-volume-low-resolution head is an industrial spray system.

### BRIEF DESCRIPTION OF THE DRAWINGS

The present disclosure will be understood and better appreciated from the following detailed description taken in conjunction with the drawings. Identical structures, elements or parts, which appear in more than one figure, are generally labeled with the same or similar number in all the figures in which they appear, wherein:

FIG. 1 is a schematic illustration of an additive manufacturing system for manufacturing seamless fabric and/or foam products comprising different properties at predetermined sections along the product, according to embodiments of the disclosure;

FIG. 1A is a schematic illustration of a top view of a precise liquid placement head operating via mechanical pumps, according to embodiments of the disclosure;

FIG. 1B is a schematic illustration of an additive manufacturing system, according to embodiments of the present disclosure;

FIGS. 2A-2C are schematic illustrations of the structure of the output holes of the printing head of the system, an example of active output holes and an example of a pattern created by the output holes, respectively, according to embodiments of the disclosure; and

FIGS. 3A-3B are schematic illustrations of a product during manufacturing and a product after manufacturing, respectively, thereby illustrating the manufacturing process of seamless fabric and/or foam products comprising different properties at predetermined sections, according to embodiments of the disclosure.

### DETAILED DESCRIPTION

the present disclosure provides a system and method for producing seamless fabric and/or foam products comprising different properties at predetermined sections while using additive manufacturing.

The present disclosure provides a method of additive manufacturing (AM) used for creating seamless textile products or fabric products made into a specific shape. The method is capable of “free style” three-dimensional (3D) rendering of the fabric shape and structure, by implementing precise controlled placement of liquid polymers within a tolerance of ±1 mm, or less, optionally associated with short loose fibers, of for example, 0.2 to 10 mm long onto a printing bed that has no predesigned shape of its own. The printing bed according to the present disclosure may be merely a base onto which printing of the textile and/or foam product is performed. However, in other embodiments, the printing bed may have a predesigned shape onto which the accurate deposition of liquid droplets takes place. In other embodiments, other lengths of short loose fibres may be implemented.

In some embodiments, the method allows manufacturing of sophisticated 3D customized fabrics with precise boundaries and/or sections, instantly, within minutes. For example, a medium sized T-shirt can be manufactured by the disclosed AM method within approximately five minutes, not including final curing. Since curing may be conducted externally to the AM system of the present disclosure, manufacturing of another product can begin during curing of a previous product, without restricting the AM system's throughput. The 3D customized fabrics' shapes may be derived from digital information, e.g., input provided to the control system that is part of the AM system of the present disclosure. The input may be in the form of a computerized design file, or any other format.

In some embodiments, the method utilizes precise liquid application equipment, to create accumulated liquid droplets overlay, allowing deposition of short fibers and other additives precisely onto the liquid, e.g., via flocking. One example of a suitable free-style 3D rendering droplets-placement device is a Mechanical Micro-dosing Head, an inkjet or any other drop-on-demand system.

According to some embodiments, the method comprises at least one session of accurate liquid droplets placement or deposition, on a printing surface, e.g., of a flat or curved printing bed, or on a surface of a 3D shaped mold, or on a surface of a semi-finished workpiece to complete such workpiece.

In some embodiments, the surface on which the droplets are applied may be geometrically textured to create the same texture on the surface of the AM printed fabric facing the printing bed. For example, a texture representing animal hide or any type of fabric knitting, e.g., single jersey knitted fabric.

In some embodiments, the method may comprise multiple sessions of precise placement of liquid polymer droplets, on predetermined, designated section(s) of the printing bed, mold, or semi-finished workpiece so to form a designed polymeric structure in the X, Y and Z axes.

In some embodiments, the method may comprise deposition of polymer liquid droplets from a high-resolution precise liquid placement (PLP) head, as well as deposition of polymer liquid droplets from a high-volume-low-resolution, non-precise industrial spray system, e.g., an airless or air assisted spray gun. The polymer liquid droplets may be waterborne polymer or waterborne resin. The high-resolution deposition may be followed by the low-resolution deposition, or vice versa, and so on, until the entire fabric and/or foam product is created. This method may create a two-fold fabric, which comprises at least two types of fabrics seamlessly connected or fused to one another, since the two types are manufactured during a single process. For example, one section of the fabrics may be a “base overlay” a plain layer, or a first layer that includes less details and may thus be manufactured via the high-volume-low-resolution deposition head, which is configured to deposit the polymer liquid droplets at a relatively fast output rate, e.g., two times, or three times or four times or even ten times higher compared to the output rate of a precise liquid placement (PLP) head. Whereas another section of the fabric, which is seamlessly connected in a continuous manner to the first one due to the continuous manufacturing process, may be a “detailed overlay” that includes many details and should thus be manufactured via the high-resolution deposition head, which is slower compared to the high-volume-low-resolution deposition head but is more accurate, thus its higher resolution, which may be at least five times more than resolution of the high-volume-low-resolution deposition head.

For example, the precise liquid placement (PLP) head may be used for sections of the product that require high precision, e.g., the contour of the product, while the rest of the product, assuming it requires less accuracy, may be manufactured by operation of the high-volume-low-resolution deposition head.

In some embodiments, the manufacturing method may comprise similar reoccurring sessions of precise placement of liquid polymer droplets, while in other embodiments, the multiple sessions are different sessions, e.g., the type of liquid polymer used in each session may differ, the duration of each session may differ, the location of placement of the liquid polymer along the X, Y and Z axes and any rotational angle of the printing surface may be different between sessions, or any combination thereof.

According to some embodiments, examples of semi-finished workpiece may be automotive plastic parts and carbon fibers fabrics, onto which fabric may be connected to produce a complete product.

In other embodiments, the system and method of the present disclosure may enable manufacturing of a product that includes both fabric and foam, which are seamlessly connected to one another as they are manufactured during the same process one followed by the other. This could be useful for many implementations, such as in the vehicle industry, for padding the internal surface of the vehicle as well as combined padding or upholstery of a vehicle's seat, by having the padding include at least one foam layer covered by at least one fabric layer of any shape and texture.

One of the advantages of the disclosed AM manufacturing technology is its ability to effortlessly and automatically create seamless fabric and/or foam products that are characterized by having different properties in designated sections of the seamless fabric and/or foam product, anywhere along the X, Y and Z dimensions, at a precision and/or resolution of at least ±1 mm, e.g. ±2 mm, or better. This method eliminates the need for manual cutting or cutting whatsoever. Such high resolution is better than the resolution typically achieved by traditional textile cutting devices, such as scissors.

In some embodiments, manufacturing of fabric products may incur use of spraying machines to spray the short loose fibers following the polymer liquid droplets deposition. This AM fabric products manufacturing method may further eliminate the need of using masks as required to block spray at certain sections to avoid spray from reaching certain locations.

According to some embodiments, the placement of the liquid droplets and fibers may be controlled by a software-driven computerized control system (as will be detailed below), which may be fed by input, e.g., digital media or files. The digital files may be generated by product designers or fashion designers and may be sent to the control system, locally or remotely, and the control system will operate the relevant elements of the manufacturing system, e.g., the PLP head and the high-volume-low-resolution head, to create the desired product or fashion item per the input fed into the control system. By controlling operation of the PLP head and the high-volume-low-resolution head, the control system optimizes operation of those heads with respect to manufacturing time and product quality, such that areas that require less accuracy may be created via high-volume-low-resolution head, which takes less time, than areas of many details and which require higher accuracy, which may be manufactured via the PLP head, which typically takes longer compared to operation of the high-volume-low-resolution head.

By the accurate deposition of liquid droplets, together with deposition of short fibers such as textile fibers, and perhaps other additives, and in some cases the low-resolution deposition of accumulated liquid droplets, the fabric product attributes such as thicknesses, colors, stretchability, rigidity, textures, hand-feel, drape, smell, tear strength, puncture resistance, breathability, or any other desired attributes, may be achieved at any designated section of the fabric and/or foam products.

In some embodiments, drying, curing, part drying, or part curing of the fabric and/or foam product, may be conducted between any two adjoining overlays, or between any adjoining sections of the fabric and/or foam product, to create good and sufficient bonding between the droplets of one deposition session and the droplets of a sequential deposition session, as the semi-wet droplets at least partly merge with each other so that sections can be fused seamlessly and effortlessly without the need of stitching or gluing, which are required in traditional fabric manufacturing methods, without mixing between one overlay to another.

In some embodiments curing, part curing, drying and part drying are conducted by blowing hot air on or around the liquid polymeric droplets or layer, that is created during the process, or by heating the printing bed, or by combination of printing bed heating and surrounding air heating or blowing.

In some embodiments, at the end of the deposition process of the polymer liquid droplets, and when completing the predefined design of the product, a final step of curing may be implemented, which may be using heating at high temperature, polymerization, e.g., via high temperature, via accelerators pre-carried within the waterborne polymer liquid droplets, and so on. After the final curing, the product may be ready for use.

Other curing methods may be implemented.

In some embodiments, short fibers may be applied at any desired deposition session.

In some embodiments, some examples of fibers may comprise textile fibers, carbon fibers, Kevlar fibers, glass fibers, etc.

In some embodiments, additives may be applied in any designated section, at any desired deposition session.

In some embodiments, some examples of additives may comprise fire retardants, scents, blowing agents, conductive elements, color pigments etc.

In some embodiments, the AM manufacturing method for manufacturing precise fabric products may comprise applying layers of liquid polymer according to a predetermined 3D design, thereby eliminating the need for a pre-shaped printing bed. The applying operation may comprise applying different types of material at designated areas along the 3D product.

In some embodiments, the method may further comprise adding fibers, e.g., short fibers onto the polymer to create the final fabric product.

In some embodiments, the AM manufacturing method for manufacturing the fabric products, which are characterized by having different properties in designated parts, along the X, Y and Z dimensions, may comprise precisely placing foam overlay, which may be created by adding a blowing agent to the polymer at the time of applying the polymer, to cause the polymer to expand, thereby creating foam. For example, the blowing agents may comprise EDOLAN XPS by TANATEX, though other blowing agents may be incorporated for foam creation. In some embodiments, the foam may be created by mixing the water-based polymer liquid, which causes air bubbles to enter therein.

The ability to precisely print different grades of foam as desired, at any designated area in the X, Y and Z axes, is of great advantage, as it is very difficult to 3D print foam and further difficult to control the shape and the boundaries of foam without forming it inside an enclosure. More than that, creating variable, gradient foam, with gradient compression strength, for example, by having a gradient ratio of bubbles and polymer, or by using different polymeric formulas, which are changing gradually in at least one dimension of the foam structure, and forming a variable yet continuous and seamless foam sheet, without the need for bonding or joining different foam grades is novel and unique to the present disclosure. As explained hereinabove, since the polymer liquid droplets whether deposited from the PLP head or the high-volume-low-resolution head, are water-based polymers, once they are applied onto the printing surface, there may be a semi-curing, or semi-drying process, e.g., via air blowing, that causes the applied droplets to create a layer of at least partially connected droplets. Then another layer of polymer liquid droplets may be applied, such that the newly applied layer may be seamlessly fused with semi-wet first layer, without being mixed into it, and maintaining a distinction between the first layer and the second layer, that is seamlessly connected to it. This may be done repeatedly until the entire product is completed, and possibly a full curing process is performed.

In some embodiments, the method may be used for the creation of a seamless foam and foamless overlays, as one monolithic product. Thus, the method eliminates the common process of gluing fabric, a leather substitute to foam, as done, for example, in the upholstery industry.

In some embodiments, the method may be used for manufacturing two-fold or composed fabrics, comprising at least one base overlay and at least one detailed overlay. In some embodiments, the base overlay may be created at ‘high-speed-low-resolution’ manner to maximize manufacturing throughput, while the detailed overlay may be created at ‘low-speed-high-resolution’ manner. In some embodiments, the detailed overlay may serve as performance enhancers and/or decorative elements.

In some embodiments, the composed fabrics, the two-fold fabrics, the foam or the foam and foamless product may be implemented as part of wearables.

In some embodiments, the detailed overlay may comprise conductive leads for electronics, sensing and transfer of data.

In some embodiments, the method may utilize the precise liquid application equipment, to apply the liquid polymer materials in any desired angle by moving, tilting and rotating the printing bed, to maintain horizontal orientation of the printing bed with respect to the floor, such to prevent dripping of the liquid polymer due to gravitational force, so that complicated 3D shapes may maintain material properties and thickness consistency during the deposition session along the entire product area, even when the sheet or printing surface is curved. That is, when the printing bed is relatively parallel to the floor, the gravitational force would cause the polymer liquid droplets to be pulled towards the ground, i.e., towards the base of the printing bed, and not towards the sides of the printing bed or the sides of the substrate or mold that are droplets are deposited thereon.

In some embodiments, the method may utilize multiple materials application heads, to produce a fabric and/or foam product. For example, at least two heads used for the creation of the product substantially differ in output rate and resolution, so that the output rate of one head is, for example, at least as twice, or preferably at least three times higher in comparison to the other head output. This may allow saving production time since an overlay or a section acting as a filler may be created at high speed and low resolution, for example, to produce a base overlay, while additional overlays and sections, for example, performances and/or decorations, may be created at low speed but at high resolution, creating very fine details. Thus, the method maximizes efficiency and throughput of the precise liquid placement while keeping high precision details all in one process.

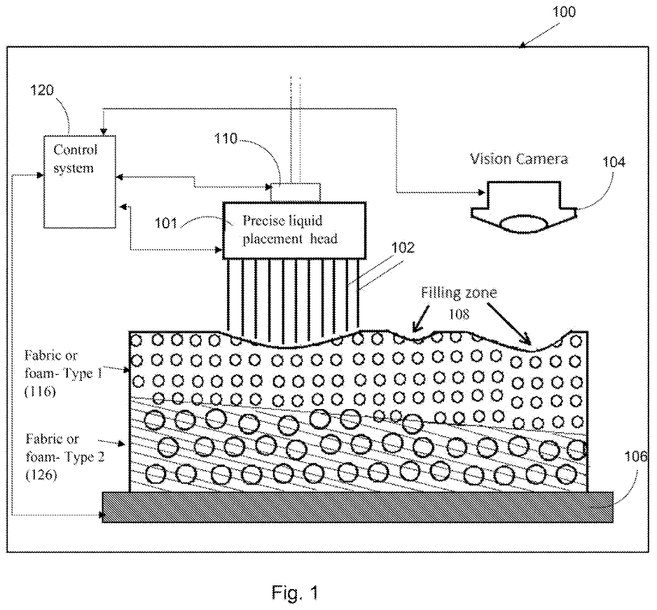

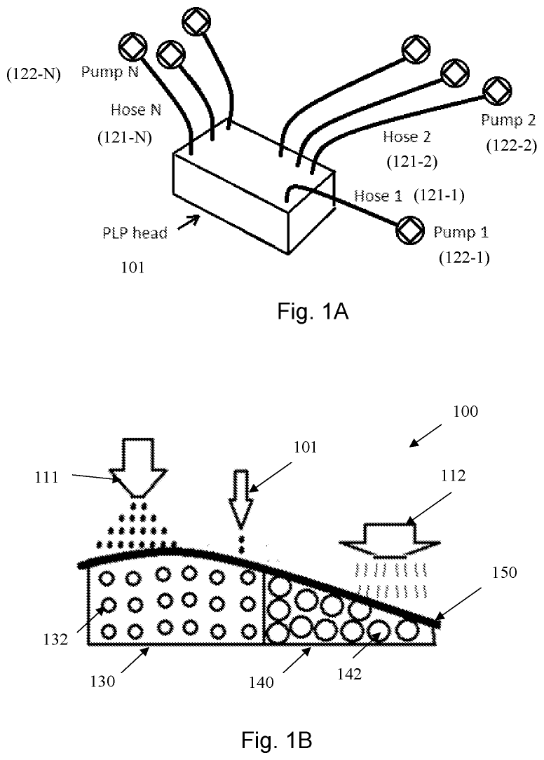

Reference is now made to FIG. 1, which is a schematic illustration of an additive manufacturing system for manufacturing seamless fabric and/or foam products comprising different properties at predetermined sections, according to an embodiment of the disclosure.

In some embodiments, AM system 100 may comprise a precise liquid placement (PLP) head 101, through which liquid polymer droplets 102 are applied onto a printing surface or printing bed 106.

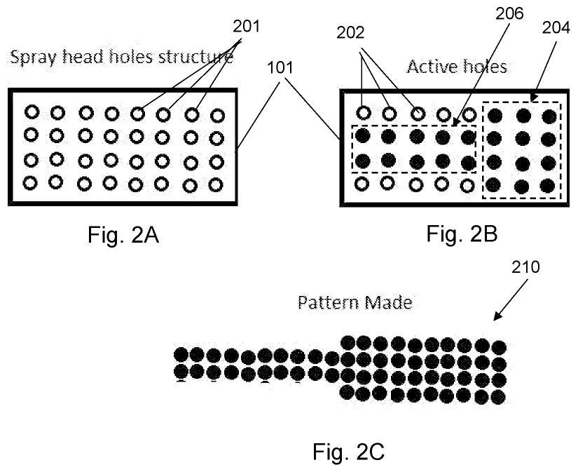

In some embodiments, PLP head 101 may comprise an array of outlet holes, e.g., outlet holes 201 (FIG. 2A). Different types of liquid droplets 102 may be disposed or pushed out of PLP head 101, at a pre-programmed process for manufacturing a product of certain shape and size, as set on and executed by a software-driven computerized control system 120, which may be fed by digital media or digital files. The precise liquid placement head 101 may dispose or apply material with no over spray (which is spray exceeding the boundaries of the preprogrammed product's shape and size) at a precision and/or resolution of at least ±2 mm, and preferably at a precision/resolution of at least ±1 mm.

In some embodiments, as illustrated in FIG. 1A, which is a schematic illustration of a top view of a precise liquid placement head operating via mechanical pumps, according to embodiments of the disclosure, the PLP head 101 may operate by mechanically applying direct pressure on the liquid, e.g., by using a Micro-dosing mechanical pump. For example, the micro-dosing mechanical pump may be any one or more of variable displacement plunger pump, micro piston pump, Micro-screw, and so on.

Due to the need to precisely dose variable amounts of liquid, at a given time, the PLP application head 101 may comprise a very crowded array of nozzles or orifices, e.g., at a distance of 1-3 mm between two adjacent nozzles. Each of the nozzles 1 to N (N being any number larger than 1), illustrated in FIG. 2A at nozzles 201, is equipped with a respective hose 121, indicated as (121-1), (121-2), . . . (121-N) of a diameter of, for example, 2 mm. Each hose 121 and thus each nozzle 201 may be operatively connected to a single corresponding remote pump 122, indicated as (122-1), (122-2), . . . (122-N). This arrangement that includes hoses 121 that may distant the location of the pumps 122 with respect to PLP head 101, allows maximizing the number of orifices or nozzles 201 in the PLP head 101, while allowing much bigger space for the pumps. This arrangement also allows disposing different amount of liquid via each nozzle 201, and also disposing different material, polymers, and colors, at the same printing session, by each nozzle 201 being separately controlled by a dedicated pump 122.

The use of mechanical pumps allows disposing very high viscosity liquids, gels and hydrogels, in the range of 80 to 2000 cP and more.

The use of mechanical pumps allows disposing much higher amounts of liquids in comparison to inkjet technologies or in comparison to any drop-on-demand technology, thus allowing superfast production.

Typically, the mechanical micro-dosing is capable to dispose at least as twice or at least three times the amount of any other similar system, thus improving the output and efficiency of Additive Manufacturing PLP head 101.

In some embodiments the PLP head 101 may be based on ink jet technology.

In some embodiments the AM system 100 may comprise at least one mechanical micro-dosing PLP head, which may apply high viscosity liquids and gels, and at least one ink jet head, which may apply lower viscosity liquids.

In some embodiments, AM system 100 may further comprise a movable and tiltable holding device 110, which may be configured to hold PLP head 101, and may be capable of moving the precise liquid placement head 101 along X, Y, and Z axes, as well as rolling PLP head 101 in RX, RY, and RZ axes, thereby controlling the angle of the spraying or deposition direction; and may also allow maintaining the optimal distance and angle between PLP head 101 and printing surface 106, whereby the optimal distance and angle are determined per the type of disposition head used and the characteristics of the deposited waterborne polymer.

In some embodiments, printing surface 106 may be a flat printing bed, a curved printing bed, a three-dimensional printing bed or a semi-finished product (e.g., a part of a product that has not been completed).

In some embodiments, printing surface 106 may be movable and tiltable, and moving the printing surface 106 may allow adjusting the angle of the printing surface 106 relative to the ground, e.g., a floor, representing a horizontal reference plane. Thus, in case the printing is conducted on a curved surface, the area on which the application head 101 applies materials may be brought to a position, parallel to the ground as desired. The tilting of printing surface 106 may adjust the position of printing surface 106 with respect to PLP head 101, such to prevent polymers and other applied materials from dripping and spilling, as the gravity vector, affecting the liquids, fibers and additives and any other applied material, is minimized.

In some embodiments, moving and tilting of the printing surface 106 may be conducted by any holding device or system, e.g., similar to holding device 110.

Examples of movable and tiltable holding devices are robotic arms and a controlled independent flying device such as a drone, or any other mechanism.

In some embodiments, AM system 100 may comprise a housing containing at least a moveable ink jet head, comprising a PLP head 101 and a moveable holding device 110, and a printing surface 106, whereby the housing may comprise at least one access door for the user to be able to reach the components of system 100 and to make any manual adjustments to any of the components of system 100.

According to some embodiments, AM system 100 may further comprise a software driven computerized control system 120. In some embodiments, control system 120 may control the PLP head 101, the ink jet head holding arm 110 and the printing surface 106. That is, control system 120 may control printing characteristics of PLP head 101, may control movements of the movable holding device 110, as well as movements of printing surface 106.

Reference is now made to FIG. 1B, which is a schematic illustration of an additive manufacturing system according to embodiments of the present disclosure. In some embodiments, AM system 100 may comprise a PLP head 101 and a high-volume-low-resolution head 111. In some embodiments, AM system 100 may further comprise a flocking system 112.

When more than one deposition heads are included in system 100, e.g., when a high-volume-low-resolution head 111 is included, control system 120 is configured to further control operation of the high-volume-low-resolution head 111 and of the PLP head 101.

In some embodiments, control of the printing characteristics of spraying PLP head 101 (and/or of any other spraying head, e.g., high-volume-low-resolution head 111) may include at least one of the following parameters or any combination thereof:
1. mode of operation: continuous or non-continuous “dotted line” liquid droplets application,
2. the number of drops deposited every predetermined period of time, e.g., every second,
3. the speed at which the drop leaves a hole orifice/nozzle,
4. the amount of liquid deposited in every drop, or at any given series of droplets,
5. the type of liquid material applied per every drop or per every session of printing,
6. the order and duration of materials applied per each session.

In some embodiments, when AM system 100 is configured to create a foam product with or without a foamless section, control of high-volume-low-resolution head 111 may comprise controlling the different properties of the foam product, e.g., controlling softness and weight per volume, by controlling the type of material of the polymer liquid droplets and the ratio between the material of the polymer liquid droplets, air concentration mixed within, or amount of blowing agent mixed within the material of the polymer liquid droplets.

In some embodiments, AM system 100 may further comprise a vision/imaging system or camera 104 to allow tracking and correcting placement of the applied material by PLP head 101 during or between the deposition sessions. The collected image data may be transferred to control system 120 to be analyzed such to improve operation of control system 120, to determine whether any adjustments are required in controlling position of the PLP head 101 or position of the printing surface 106 with respect to one another, or any other change in any of the controllable components of system 100.

In some embodiments control system 120 may control operation of camera 104.

In some embodiments, AM system 100 may comprise a power source for operating each and every part of the system. The components of AM system 100 may be connected to the power source via wires. In some embodiments the power source may be the electric power socket, while in others it may be a battery, e.g., a chargeable battery.

In some embodiments, AM system 100 may further comprise a secondary high-volume-low-resolution, non-precise spray gun 111, for example: an airless or air assisted spray gun, or electro-static spray gun. Such high-volume-low-resolution guns typically do not have a precisely defined resolution. Their nozzle type and spray pattern may have a practical resolution of several centimeters and the spray pattern they create have blur, unclear boundaries. According to some embodiments, the ratio between the polymer deposition capability of the high-speed-low-resolution spray gun and the low-speed-high-resolution PLP head 101 may be at least 50% but preferably at least 300%. The high-volume-low-resolution spray gun may be configured to apply material coverage fast where there is no need for precise material application, e.g., such that the quickly applied material is acting as filler 108 neighboring or surrounding the detailed layers deposited by the PLP head 101. In some embodiments, the primary PLP head 101 and the high-volume-low-resolution head 111 may be operated simultaneously, i.e., at the same time, or one following the other.

In some embodiments, precision and resolution of the depositing via the precise liquid placement (PLP) head 101 may be of at least ±1 mm, and precision and resolution of the high-volume-low-resolution head 111 may be between 0.5 cm to 100 cm, e.g., between 0.5 cm to 80 cm. Accordingly, resolution of the PLP head 101 may be at least five times higher than that of the high-volume-low-resolution head 111.

In some embodiments, AM system 100 may further comprise a controllable application head equipped with a ‘narrow tip’ polymers' deposition nozzle, as explained hereinabove with respect to FIG. 1A, which may be capable of creating continuous polymer lines or polymer strands at a width range of, for example, 0.3 to 5 mm. The purpose of the narrow tip nozzles may include, for example, creating a thickened stronger line to prevent tearing, creating a precise visual design element, etc.

In some embodiments, AM system 100 may further comprise a flocking system 112 of any kind, configured to apply loose short material particles such as short loose fibers, to attach onto the liquid polymer.

According to FIG. 1B, the high-volume-low-resolution head 111 is configured to deposit polymer liquid droplets to create section 130, which is a hard foam as it contains smaller air pores 132, compared to foam 140, which is softer than foam 130, as it contains larger air pores 142. Once high-volume-low-resolution head 111 ends its operation, since the shape of the foam or fabric is according to the predefined design, in some embodiments, another overlay may be applied onto the current product shape, by either high-volume-low-resolution head 111 or by PLP head 101, or by both. Overlay 150 may be applied on top of the present fabric or foam product, e.g., foams 130 and 140, e.g., via PLP head 101.

Application of polymer liquid droplets to create layer 150 may be done before curing of the former layers, e.g., foams 130 and 140, such that layer 150 is seamlessly fused to the former layers. After creation of layer 150, flocking system 112 may be operated to deposit short loose fibers, to create some kind of textile feel and/or pattern, e.g., of artificial leather or any other fabric pattern.

AM system 100 need not include flocking system 112, though does include flocking system 112 when short loose fibers are to be part of the fabric of foam final product. In some embodiments, AM system 100 may further comprise an automated cleaning system, for cleaning the inner walls of AM system 100 or any other part of AM system 100, which are contained within the enclosure of AM system 100.

In some embodiments, AM system 100 may further comprise a reclaiming and recycling unit for recycling applied materials that were applied out of the printing bed boundaries, e.g., materials applied by a secondary high-volume-low-resolution spray gun. Those materials that were deposited during manufacture but were not part of the final product may be collected for re-use.

In some embodiments, AM system 100 may further comprise a curing system(s) for curing the applied liquid material to thereby create a final product.

In some embodiments, AM system 100 may further comprise an air conditioning system configured to control and maintain a constant temperature and/or humidity within the enclosure of AM system 100.

In some embodiments, AM system 100 may further comprise an air filtering system for cleaning the polluted air within the enclosure of AM system 100 before opening the access door of AM system 100.

In yet another embodiment, the secondary standard ‘high-volume-low-resolution’ spray gun 111 may be an electrostatic spray gun.

In some embodiments, any of the liquid application heads may be connected to more than one feeding hose, to enable instant change of dosed liquid material, for example, for applying different colors or different polymers within almost no delay between one application session to another. Thus, creating decorations may be performed as an integral part of the fabric and/or foam product's creation.

Reference is now made to FIGS. 2A-2C, which are schematic illustrations of the output holes of the printing head of the system, an example of active output holes and an example of a pattern made by the output holes, respectively, according to embodiments of the disclosure.

In some embodiments, multiple nozzles 201 may be arranged in a row, a line, or in any other array configuration along PLP head 101. Each of the nozzles, e.g., nozzles 201 may be connected to a single respective pressure source (e.g., pump 122, FIG. 1A), generated by piston, plunger, or diaphragm, via one channel, whereby the channel may be a hose (e.g., hose 121, FIG. 1A) or an internal tunnel of the PLP head 101.

In the example illustrated in FIG. 2B, PLP head 101 may comprise spray heads holes or nozzles 201 while during operation, some of the nozzles 201 may be active holes 204 and 206. Accordingly, nozzles 204 and 206 may apply liquid polymer material, whereas some nozzles, e.g., nozzles 202 may be inactive nozzles, such that nozzles 202 may not be used for liquid application.

A user may create various patterns by activating some nozzles, while inactivating other nozzles, e.g., via control system 120. For example, pattern 210 in FIG. 2C may be created by activating nozzles 204 and 206, while inactivating nozzles 202, and by further timing the activation of nozzles 204 with respect to operation of nozzles 206, such that nozzles 204 and nozzles 206 aren't necessarily operated at the same time.

In the pattern example illustrated by FIG. 2C, control system 120 may control operation of the various nozzles such that nozzles 204 are activated, while nozzles 202 as well as nozzles 206 are inactivated. Then, after a certain period of time and after either printing surface 106 has moved, e.g., to the right, or PLP head has moved to the left, nozzles 206 are activated for liquid application, along with nozzles 204. After another period of time, when either printing surface 106 is moved to the right or PLP head 101 is moved to the left, nozzles 202 as well as nozzles 204 are inactivated and only nozzles 206 continue to apply liquid material onto printing surface 106, thereby creating pattern 210.

In some embodiments, AM system 100 may comprise several polymers' application heads, working in collaboration, such as a combination of, air-assisted, airless, electrostatic and Mechanical Micro-dosing spraying heads, to optimize production speed and polymer application resolution.

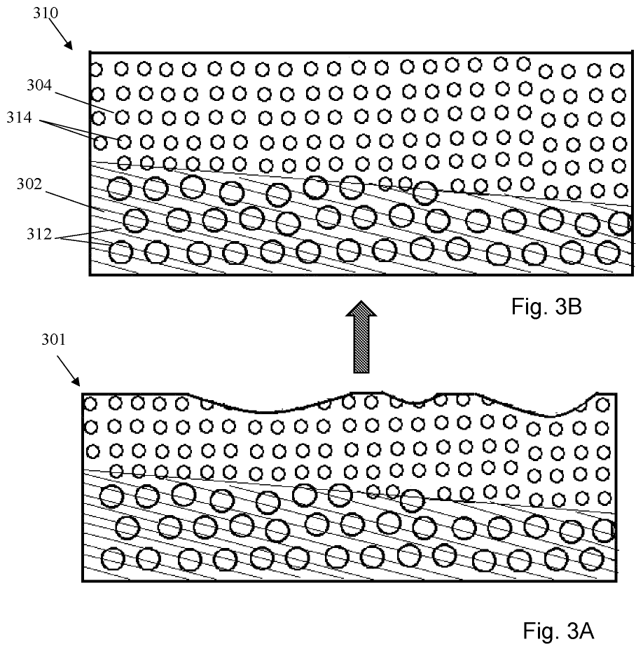

Reference is now made to FIGS. 3A-3B, which are schematic illustrations of the manufacturing process of seamless fabric and/or foam products comprising different properties at predetermined sections, according to embodiments of the disclosure. In some embodiments, AM system 100 may create a foam and/or fabric product by applying droplets of liquid polymer to create a 3D product. In the example illustrated in FIGS. 3A-3B, foam is created, and the pores or air bubbles creating the foams are illustrated as pores 312 and 314. Foam 301 in FIG. 3A may illustrate a foam product, which is not yet completed, while foam product 310 in FIG. 3B illustrates a complete foam product. In this example, the foam product 310 is comprised of two types of foams, with different size of pores, and possibly different types of liquid material applied. The location along foam product 310 of where one type of foam, e.g., foam 302 with pores 312, is completed and a second type of foam, e.g., foam 304 with larger pores 314 begins, may be predetermined and controlled by control system 120.

In some embodiments, the vision camera or imaging system 104 (FIG. 1) may be employed in conjunction with the application head, e.g., PLP head 101, or the high-volume-low-resolution spray gun, or both, as well as the computerized control system 120, to trim and adjust forming the shape of foam and/or fabric, in a continuous manner. By acquiring images and continuously analyzing the results of the so-far created foam or fabric imaged by imaging system 104, and via communication between the imaging system 104 and control system 120, control system 120 may continuously adjust location and operation of the application head(s), if and as needed, in order to meet the pre-planned or predefined shape and design of the foam and/or fabric.

It should be appreciated that the above-described methods and system may be varied in many ways, including omitting or adding elements or steps, changing the order of steps and the type of devices used at each step. It should be appreciated that different features may be combined in different ways. In particular, not all the features shown above in a particular embodiment are necessary in every embodiment of the disclosure. Further combinations of the above features are also considered to be within the scope of some embodiments of the disclosure.

It will be appreciated by persons skilled in the art that the present invention is not limited to what has been particularly shown and described hereinabove.

1. An additive manufacturing method for creating a seamless fabric and/or foam product comprising different properties in different designated sections along the fabric and/or foam product, the method comprising:
depositing polymer liquid droplets on a printing surface via a precise liquid placement (PLP) head;
depositing polymer liquid droplets on a printing surface via a high-volume-low-resolution head; and
controlling operation of the precise liquid placement (PLP) head and of the high-volume-low-resolution head, thereby controlling the different properties of the seamless fabric and/or foam product, via a computerized control system, wherein controlling the operation of the precise liquid placement (PLP) head and of the high-volume-low-resolution head comprises controlling continuous or non-continuous liquid droplets depositing, the amount of liquid deposited in every deposition session, or at any given series of spray session, the type of liquid material applied per every session of droplets application, the order and duration of materials applied per each session of droplets deposition, or any combination thereof.

2. The method of claim 1, wherein the polymer liquid droplets are waterborne polymer or waterborne resin.

3. The method of claim 1, further comprising depositing short loose fibres via a flocking system.

4. The method of claim 3, wherein said short loose fibres are textile fibres.

5. The method of claim 1, wherein the polymer liquid droplets deposited via a precise liquid placement (PLP) head and the polymer liquid droplets deposited via a high-volume-low-resolution head, comprises additives, wherein said additives are fire retardants, scents, blowing agents, conductive elements, colour pigments, or any combination thereof.

6. (canceled)

7. (canceled)

8. The method of claim 1, wherein controlling the operation of the precise liquid placement (PLP) head comprises controlling number of droplets deposited at every predetermined period of time.

9. The method of claim 1, wherein output rate of the depositing of liquid droplets via the high-volume-low-resolution head is at least two times higher compared to output rate of the depositing of liquid droplets via the precise liquid placement (PLP) head.

10. The method of claim 1, wherein resolution of the precise liquid placement (PLP) head is at least five times higher compared to resolution of the high-volume-low-resolution head, thereby the depositing of liquid droplets via the precise liquid placement (PLP) head is configured for creating a detailed overlay, while the depositing of liquid droplets via the high-volume-low-resolution head is configured for creating a low detail base overlay or filler overlay, which is configured to serve as a plain layer, or as a first layer onto which the detailed overlay is created, or as a filler neighbouring or surrounding the detailed overlay, respectively, further wherein controlling operation of the precise liquid placement (PLP) is performed with respect to controlling operation of the high-volume-low-resolution heads thereby optimizing operation of the heads with respect to manufacturing time and product quality.

11. The method of claim 1, wherein the controlling the different properties of the fabric and/or foam product comprises controlling attributes of the fabric and/or foam product, per any designated section along the fabric and/or foam product, said attributes of the different designated sections comprising thickness, colour pigments, stretchability, rigidity, texture, hand-feel, drape, smell, tear strength, puncture resistance, breathability, or any combination thereof.

12. The method of claim 1, wherein the different designated sections are anywhere along the X, Y, Z dimensions of the fabric and/or foam product.

13. The method of claim 1, wherein precision and resolution of the depositing via the precise liquid placement (PLP) head is of at least ±1 mm, and wherein the precision and resolution of the high-volume-low-resolution head is between 0.5 cm to 80 cm.

14. The method of claim 1, wherein controlling the different properties of the foam product comprises controlling softness and weight per volume, by controlling the type of material of the polymer liquid droplets and the ratio between the material of the polymer liquid droplets, air concentration mixed within, or amount of blowing agent mixed within the material of the polymer liquid droplets.

15. The method of claim 1, further comprising semi-curing between depositing of one layer to another layer to cause seamless fusion between the layers to create a seamless fabric and/or foam product.

16. The method of claim 1, further comprising curing performed after depositing of the polymer liquid droplets is complete.

17. An additive manufacturing system for creating a fabric and/or foam product comprising different properties in different designated sections along the fabric and/or foam product, the system comprising:
a precise liquid placement (PLP) head configured for deposition of accumulated liquid droplets;
a high-volume-low-resolution head configured for deposition of accumulated liquid droplets;
wherein resolution of deposition of the precise liquid placement (PLP) head is higher than resolution of deposition of the high-volume-low-resolution head,
a printing surface configured to receive the accumulated liquid droplets thereon; and
a computerized control system configured to control operation of the precise liquid placement (PLP) head and of the high-volume-low-resolution head, thereby to control the different properties of the fabric and/or foam product,
wherein each of the precise liquid placement (PLP) head and the high-volume-low-resolution head is attached to a movable and tiltable holding device, said movable and tiltable holding device configured to move each of the precise liquid placement (PLP) head and the high-volume-low-resolution head along X, Y, and Z axes, to roll in RX, RY, and RZ axes, thereby to control the angle of deposition direction and the distance and angle between each of the precise liquid placement (PLP) and the high-volume-low-resolution heads and the printing surface,
wherein each of the precise liquid placement (PLP) and the high-volume-low-resolution heads comprises nozzles through which the liquid droplets exit the heads,
further wherein the pump controlling each nozzle comprises controlling different amounts of liquid disposed from per each nozzle, different materials disposed from per each nozzle, timing of nozzle operation, or any combination thereof.

18. The system of claim 17, further comprising an imaging system or camera to track and correct deposition of the polymer liquid droplets to trim and adjust forming the shape of the fabric and/or foam product via communication between the imaging system and the computerized control system, in an continuous manner.

19. The system of claim 17, wherein the printing surface is moveable and tiltable to adjust its position and distance from each of the precise liquid placement (PLP) head and the high-volume-low-resolution head, per predesigned fabric and/or foam product.

20. (canceled)

21. (canceled)

22. The system of claim 21, wherein each of the nozzles of the precise liquid placement (PLP) head is operatively connected to a mechanical pump, via a hose, wherein each pump controls each nozzle separately.

23. (canceled)

24. The system of claim 17, wherein the precise liquid placement head is based on ink jet technology.

25. The system of claim 17, wherein the high-volume-low-resolution head is an industrial spray system.
